(19) United States
(12) Patent Application Publication
(10) Pub. No.: US 2008/0173579 A1
(43) Pub. Date: Jul. 24, 2008

(54) Filter pan

(76) Inventor: Hugh J. Oglesby, Lakeland, FL (US)

Correspondence Address: A. W. FISHER III, P.A., 5553 W. WATERS AVE. # 316, TAMPA, FL, 33634, US

(21) Appl. No.: 12/006,404

(22) Filed: Jan. 2, 2008

Related U.S. Application Data
(63) Continuation of application No. 10/445,677, filed on May 27, 2003, now abandoned.

(51) Int. Cl. B01D 24/02

(52) U.S. Cl. 210/483

(57) ABSTRACT

A removable filter for use with a filter pan including a pan bottom and drainage trough for separation of liquids and solids such as the separation of phosphoric acid from phosphoric slurry comprising an intermediate filter member including an upper surface and a lower surface having a plurality of filter apertures formed therethrough, a replaceable filter cloth including a plurality of filter holes disposed on the upper surface of the intermediate filter member to cover the plurality of filter apertures and a plurality of elongated substantially parallel filter support elements disposed on the lower surface of the intermediate filter member such that when the removable filter is placed in the filter pan the plurality of elongated substantially parallel filter support elements engages the pan bottom to support the intermediate filter member in spaced relation thereto to cooperatively form in liquid flow space therebetween such that liquid filtered through the plurality of filter holes and the plurality of filter apertures onto the pan bottom flows into the drainage trough.

### CROSS REFERENCE

This is a continuation application of pending application Ser. No. 10/445,677 filed May 27, 2003.

### BACKGROUND OF THE INVENTION

1. Field of the Invention

A filter for use with a filter pan to separate liquids from solids such as the separation of phosphoric acid from phosphoric slurry.

2. Description of the Prior Art

A number of filtering apparatus comprising a large horizontal filter medium for use in the production of phosphoric acid and treatment of metal ores have been developed.

Typically a pan is disposed below a filter medium to receive the filtrate. Vacuum is applied to the pan. Slurry is fed to the upper surface of the horizontal medium. Gravity and the pressure of the atmosphere cause the filtrate to pass through the medium. Solids, which are retained by the pore size of the filter medium, deposit on the upper surface, are periodically air dried and then removed either by inverting the filter or by scraping.

U.S. Pat. No. 3,139,404 relates to large horizontal rotary filter structure. A a multiplicity of filter cells, each comprising a pan and a horizontally disposed filter medium, are supported in circular array for charging, draining, and washing. Each cell is rotated at the end of each filtering cycle for discharge of filter cake. The rotary filter includes the pivotal cell filter in which each cell is mounted for pivotal inversion about an axis which extends generally radially from the center of the numerous stations past which cells rotate, and inversion and return of the cells is easily effected as with a controlling cam track.

The filter medium is typically interwoven monofilament made of polypropylene, polyethylene with some very few made of polyester. The woven cloth is supported by ribs or perforated plate to withstand the filter cake weight and effect of the vacuum.

Embedding of crystals within the cloth, tilting the pans, as described above, and intensity of washing severely limit the life of the cloth. Typical cloth life is two to three weeks before replacement.

U.S. Pat. No. 4,391,706 discloses a filter element sealing device with a metal plate and sealing strip to secure the filter cloth to the filter pan.

U.S. Pat. No. 3,491,886 relates to a polygonal filter sector with filter media or filter cloth overlaying each sector face secured in place by a stretcher frame for holding the media, or filter cloth taut over the panels.

U.S. Pat. No. 1,860,937 describes an improved means for securing filter media in a disc filter to permit more easily replacing and renewing filter leaves.

U.S. Pat. No. 4,547,288 teaches a metallic profile wire screen for a filter surface for use with a tilting pan type filter exhibiting sufficient open area for acceptable liquid flow with optimum spacing between the profiled wires for the retention of solids being filtered.

U.S. Pat. No. 6,116,431 relates to a horizontal circular filter including plural filter pans arranged in a circle and rotatable as a group around a fixed central vacuum box. The filter pans are connected to sections of the vacuum box by respective manifolds that rotate with the filter pans. Each of the filter pans comprises a pan having a flat bottom wall including plural filtrate drainage troughs therein. A removable, disposable, plastic channel-forming grid is positioned on the bottom wall between the side walls of the pan. A filter cloth is disposed over the grid, and a cloth “caulking” arrangement secures the filter cloth in place so as to also hold the grid in place in the pan. A method of retrofitting existing punched plate filter pans is also provided.

U.S. Pat. No. 5,124,037 describes a device for filtration of solid element contained within liquid comprising a filter cloth and a structure for supporting the filter cloth capable of tilting about a horizontal axis and comprising a peripheral groove of uniform cross-section. The cloth is fastened to the support by a hollow tubular gasket made of elastic or substantially elastic material, arranged to interact with the groove; the tubular gasket is designed to distort transversely between a free or contracted state in which it can be easily introduced into the groove into which the filter cloth has been inserted beforehand, and a distorted or dilated state in which it locks the cloth inside the groove by pressure.

U.S. Pat. No. 5,399,265 describes a filter septum comprising a stainless steel sheet microscreen element which has uniformly distributed apertures through which a liquid to be filtered is passed from an inlet side to an exit side of the element. The apertures are preferably tapered from a larger diameter at the inlet side to a smaller diameter at the exit side of the microscreen element. A supporting metal base plate having rows of uniformly distributed holes that are larger then the apertures is brazed to the microscreen element bonding the exit side of the microscreen element to the inlet side of the base plate.

U.S. Pat. No. 5,738,787 shows a filtration plate for use in a filter pan comprising a corrugated sheet having a series of alternately upwardly and downwardly opening channels and a reinforcing material bonded to surfaces of the downwardly opening channels. The reinforcing material is effective for strengthening the sheet and retaining heat in a manner effective to slow cooling of the filtration plate during washing and to reduce heat losses from the filtration plate during filtering.

U.S. Pat. No. 3,966,610 teaches a filter in which a cake of solids deposited from a liquid slurry thereof on a generally horizontal filter medium is subjected to treatment involving passage of liquid through the cake while on the filter medium, means is provided for increasing the drainage rate of the formed cake by causing the cake to form on the medium from the slurry fed thereto by gravity settling in the liquor of the slurry and by removing liquor of the slurry from above the cake while the liquor still contains unsettled fine particles.

U.S. Pat. No. 4,655,920 describes a rotating disc filter comprised of disc sectors about a filter shaft. Saddles of a folded plate form sector deck and support for filter cloth, and the troughs of the folded plate together with the filter cloth abutting the saddles form internal filtrate channels extending from the outer periphery of the sector towards the filter shaft. Such a construction renders it possible to obtain sectors combining the requirements of large open filter cloth area, small internal volume affording for the filter operation an advantageously great ratio between filter surface and internal filtrate volume, high stability against lateral forces, and simple manufacture.

U.S. Pat. No. 3,216,576 describes a filter receiver for supporting a sheet-form filter medium and channeling the flow to an outlet, the receiver having a multiplicity of alternate parallel ribs and grooves, the grooves being narrow to channel the flow, the crests of the ribs being substantially aligned to resist the forces applied to the filter medium, some of said grooves being deeper than other of said grooves to form a plurality of deep and shallow grooves on each side thereof, each rib lying between a shallow and a deep groove being molded of soft clastomeric material, and receiving lateral support due to the material defining the bottom of said shallow groove, restraining said rib from bending under load.

U.S. Pat. No. 3,438,505 relates to a filter segment or leaf for a disc filter formed to include a pair of spaced side walls which each include a plurality of laterally extending grooves adapted to discharge into a centrally located duct means provided in the space between the side walls.

U.S. Pat. No. 3,389,800 shows a horizontal tilting pan filter having a trap in the drain region that is constructed and arranged to retain residual filtrate and prevent the backflow and rewetting of the filter medium and solids when the pan is tilted for discharge of the solids.

U.S. Pat. No. 3,387,711 describes a filter assembly having stacked plates, each having a clamping ring attached to its outer periphery and projecting upwardly therefrom and having a U-shaped, annular clamping unit secured over the ring to secure a filter element there between: each plate in the other embodiment having an annular groove in one face thereof adjacent the outer periphery, the groove having an outer periphery, the groove having an outer portion of a filter element secured therein by an annular cylindrical clamping member, securely on the filter element.

U.S. Pat. No. 3,291,312 relates to disc filters and more particularly to a sector assembly for a disc filter which provides a non-compressive mounting of such an assembly with a filter shaft while maintaining a positive seal with the associated filter shaft.

U.S. Pat. No. 3,426,909 relates to a filter support structure comprising a multiplicity of upstanding elongated, closely spaced together elements, each element having a thin leg and an outwardly convex crest substantially wider than the leg and overhanging the space between legs adjacent elements. Base sections connect adjacent elements, and the structure is formed of similar, integral sections interlocked together.

### SUMMARY

The present invention relates to a removable filter comprising intermediate filter member, a replaceable filter cloth and a plurality of filter support elements for use with a filter pan including a pan bottom and a drainage trough to filter liquid from a slurry of solids and liquids. Typically, filter devices employ a differential pressure created through vacuum or the like to permit the liquid to pass through the filter while the solids accumulate as a solid mass on a filter medium. This solid mass is then periodically discharged from the filter by dumping or scraping.

The filter comprises an.

The intermediate filter member comprises an upper surface and a lower surface having a plurality of filter apertures formed therethrough. The intermediate filter member may be constructed of a hard, rigid material such as polyethelene, polypropylene or UHMW. A wide selection of hole sizes, shapes and percent of open area is possible.

The replaceable filter cloth comprises a mesh or grid having a plurality of filter holes that can be easily replaced.

The plurality of filter support elements may be secured to the lower surface of the intermediate filter member. Alternatively, the plurality of filter support elements may be secured to the pan bottom. A cylindrical, a triangular, square, rectangular or other cross-sectional shape can be used.

In operation, the entire filter device may comprise a rotatable frame and a plurality of the filter cells mounted thereon to selectively tilt or rotate under the control of a cam about a generally radial axis. Vacuum lines are provided to produce a vacuum with every filter cell below the removable filter that extends horizontally when in the filtering position.

During the rotary travel of the frame, each cell receives a charge of solid and liquid slurry. After initial drainage of the liquid through the filter, a solid cake is subjected to repeated washing, the liquid at these stages also passes through the filter, though valved to different locations due to the increased dilution of the liquid. When washing is completed, the filter cell is inverted under the control of the cam, the solids cake being dumped into a receptacle, the filter cell is cleansed and the cycle is repeated.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a perspective view of the filter of the present invention in communication with a filter pan.

FIG. 2 is an exploded side view of the filter of the present invention in combination with a filter pan.

FIG. 3 is an exploded end view of the filter of the present invention.

FIG. 4 is a top view of the filter of the present invention.

FIG. 5 is a bottom view of the filter of the present invention.

FIG. 6 is a bottom view of an alternate embodiment of the filter support elements of the present invention.

FIG. 7 is an exploded side view of an alternate embodiment of the filter of the present invention in combination with a filter pan.

Similar reference characters refer to similar parts throughout the several views of the drawings.

### DETAILED DESCRIPTION OF THE PREFERRED EMBODIMENT

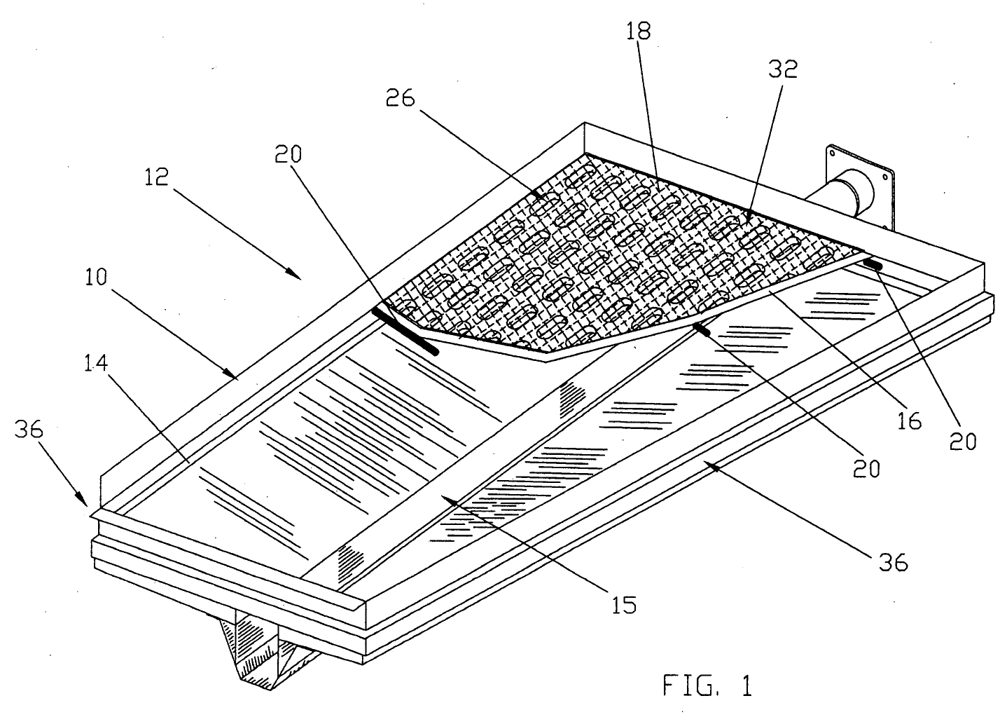

As best shown in FIG. 1, the present invention relates to a removable filter generally indicated as 10 for use with a filter pan generally indicated as 12 including a pan bottom 14 having a peripheral side wall generally indicated as 36 extending upwardly from each side thereof and a drainage trough 15 formed along the central longitudinal axis thereof.

The removable filter 10 and filter pan 12 combination is used with filters similar to that illustrated in U.S. Re 24,150 to Delruelle; U.S. Pat. No. 3,216,567 to John Roos, U.S. Pat. No. 3,425,909 to E. V. Garner and U.S. Pat. No. 6,116,431 to Barloy. Such a filter medium receives a slurry of solids and liquids. These filters by a differential pressure created through vacuum or the like permit the liquid to pass through the filter medium while the solids accumulate as a solid mass on the filter surface screen or filter medium. This solid mass is then periodically discharged from the filter by dumping or scraping.

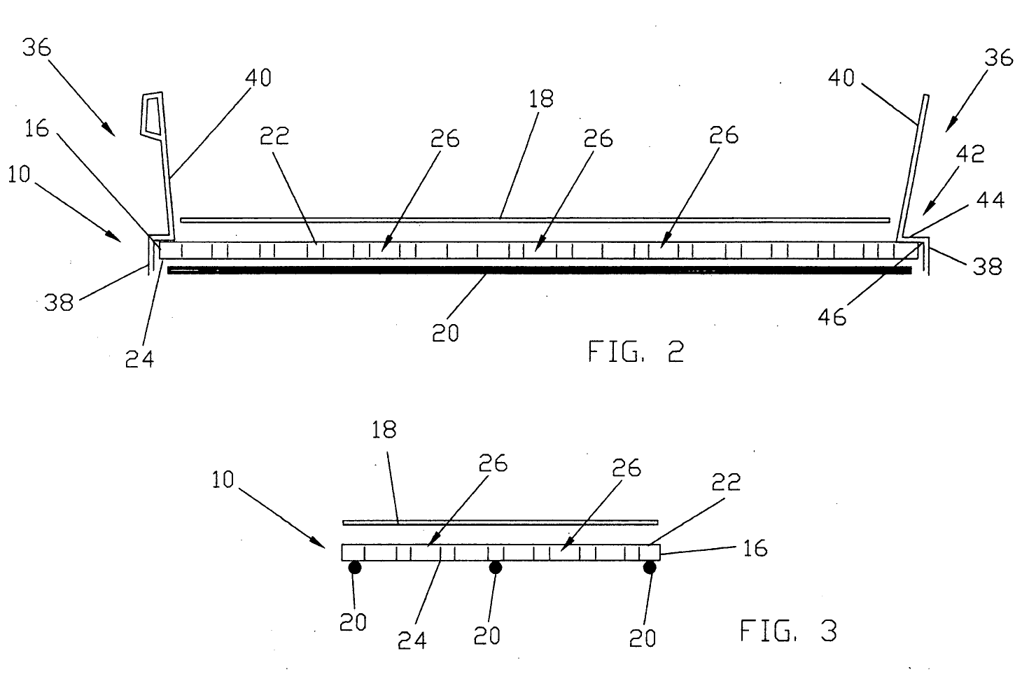

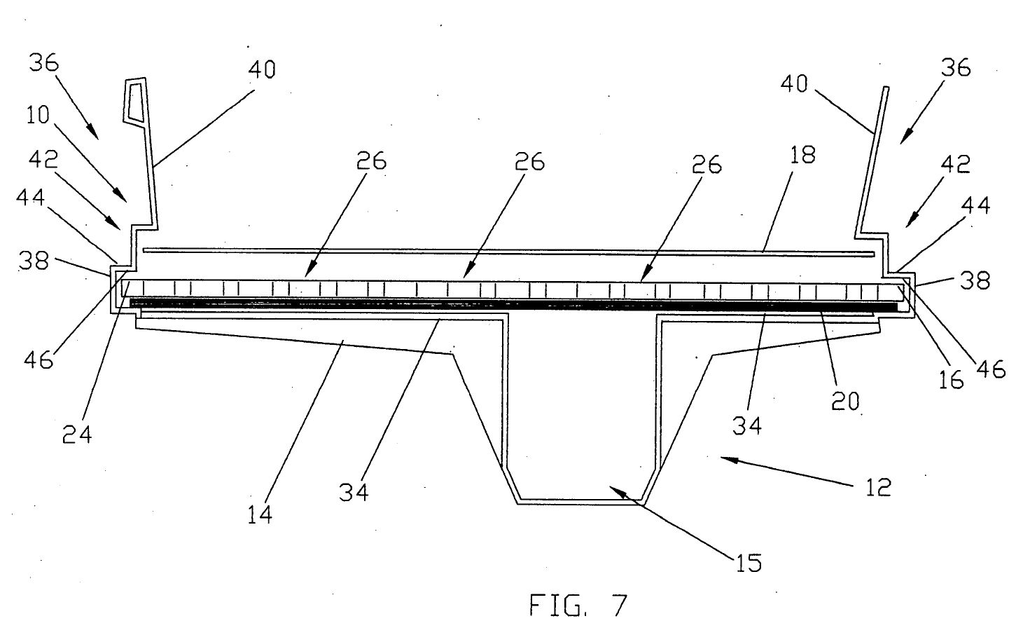

As best shown in FIGS. 2 and 7, each peripheral side wall 36 comprises a substantially vertical lower wall portion 38 and an upper wall portion 40 disposed above the removable filter 10 interconnected by a filter retainer generally indicated as 42 comprising a filter retainer member 44 including a filter retaining surface 46 disposed to engage the upper surface 22 of the intermediate filter member 16 of the removable filter 10 to retain the removable filter 10 within the filter pan 12 during use of the removable filter 10 and filter pan 12 combination.

As best shown in FIGS. 2 through 5, the removable filter 10 comprises an intermediate filter member 16, a replaceable filter cloth 18 and a plurality of elongated filter support elements each indicated as 20.

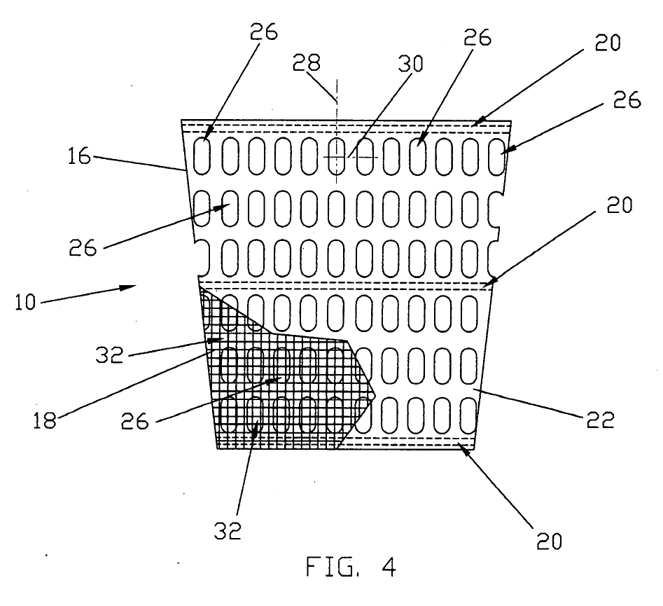

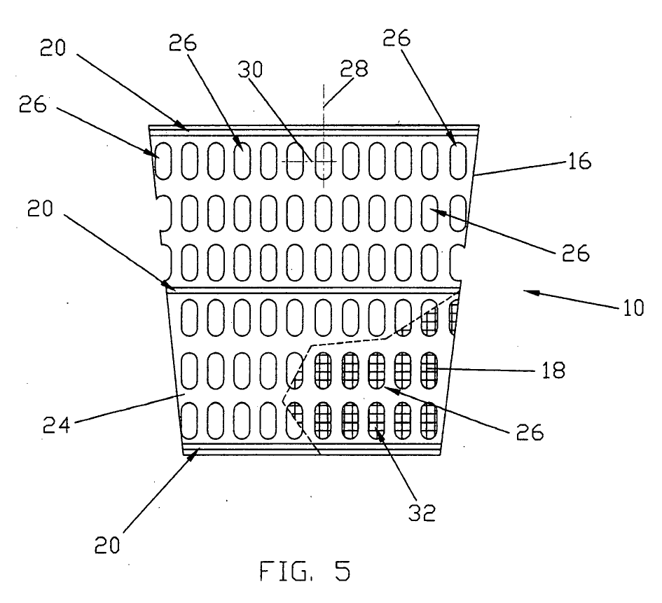

As best shown in FIGS. 2 through 5, the intermediate filter member 16 comprises a substantially flat upper surface 22 and a lower surface 24 having a plurality of filter apertures each indicated as 26 formed therethrough. As depicted, each filter aperture 26 may comprise an elongated opening having a major axis 28 having a dimension greater than a minor axis 30 (FIG. 4). The intermediate filter member 16 may be constructed of polyethelene, polypropylene, UHMW or similar material to form a relatively light, substantially rigid, support platform and may have a thickness of from about 1/16″ to about ¼″. The elongated openings may be from about ¼″ to about 1¼″ wide and about ⅝″ to about 1¼″ long. Of course, any hole size, shape and percent of open area can be employed.

As best shown in FIGS. 2 through 4, the replaceable filter cloth 18 comprises a mesh or grid having a plurality of filter holes each indicated as 32.

As best shown in FIGS. 2 through 5, each of the plurality of elongated filter support elements 20 is disposed in substantially parallel relationship relative to each other. The longitudinal axis of the elongated filter support elements 20 are substantially perpendicular to the major axis 28 of the elongated openings 26. Each elongated filter support element 20 may be constructed of high density polyethylene or similar material and may have a thickness of from about ⅛″ to about ½″. Although a cylindrical cross-sectional shape is shown, a triangular, square, rectangular or other cross-sectional shape can be used. The plurality of elongated filter support elements 20 may be welded to the lower surface 24 of the intermediate filter member 16. Alternatively, the plurality of elongated filter support elements 20 may be secured to the pan bottom 14.

In operation, a plurality of removable filters 10 and filter pan 12 in combination functioning together as a filter cell are used with the filter system comprising a rotatable frame (not shown). The plurality of filter cells are mounted on the rotatable frame to selectively tilt under the control of a cam (not shown) about a generally radial axis. Vacuum lines (not shown) produce a vacuum in the cells below the removable filter 10 that extends horizontally when in the filtering position.

During the rotation of the rotatable frame, each removable filter 10 receives a charge of solid and liquid slurry. After initial drainage of the liquid through the replaceable filter cloth 18 and the intermediate filter member 16, a solid cake is subjected to repeated washings, the liquid at these stages also passes through the filter cell, though valved to different locations due to the increased dilution of the liquid. When washing is completed, the filter cell is inverted under the control of the cam, the solids cake being dumped into a receptacle (not shown), the filter cell is washed and the cycle is repeated.

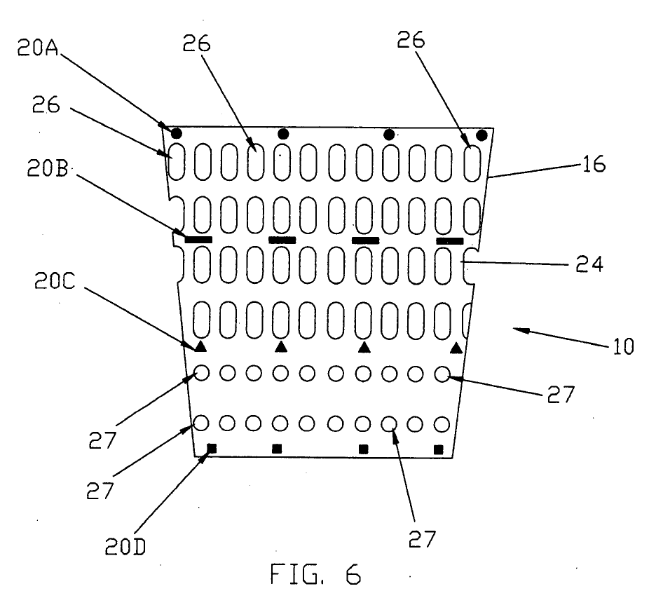

FIG. 6 shows an alternate embodiment of the plurality of filter support elements 20. Specifically, each of the plurality of filter support elements 20 may comprise a circular, triangular, oval, square, rectangular or other configuration disposed in spaced relationship relative to each other on the lower surface 24 of the intermediate filter member 16. Each elongated filter support 20 may be constructed of high-density polyethelene or similar material and may have a thickness of from about ⅛″ to about ½″. Also shown are round or circular filter apertures 27 that can range in diameter from about ⅝″ to about 1½″ in diameter.

FIG. 7 shows an alternate embodiment of the removable filter 10 used to convert Ucego type filters from vacuum over gravity method, sloped bottom perforated plate style, to high velocity vacuum extraction providing higher production rates with greatly reduced scaling tendencies and greatly reduced weight on the operational components of the removable filter 10. Specifically, the removable filter 10 comprises the intermediate filter member 16, the replaceable filter cloth 18, the plurality of filter support elements 20 and a substantially L-shaped filter support member 34 on each side of the drainage trough 15. Each substantially L-shaped filter support member 34 engages the pan bottom 14 to provide a surface to receive and support the plurality of filter support elements 20, intermediate filter member 16 and replaceable filter cloth 18.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

1-31. (canceled)

32. A filter and filter pan combination for separation of liquids and solids, said filter pan comprising a pan bottom having a peripheral side wall extending upwardly from each side thereof and a drainage trough centrally formed therein, said filter comprises an intermediate filter member including an upper surface and a lower surface having a plurality of filter apertures formed therethrough, a filter cloth including a plurality of filter holes disposed on said upper surface on said intermediate filter member to cover said plurality of filter apertures and at least three elongated filter support elements extending substantially the entire width of said filter pan and disposed to engage said lower surface of said intermediate filter member such that when said filter is operatively placed in said filter pan said plurality of elongated filter support elements engages said pan bottom to support said intermediate filter member in spaced relation thereto to cooperatively form in liquid flow space therebetween wherein liquid filtered through said plurality of filter holes and said plurality of filter apertures between said elongated filter support elements into said drainage trough wherein each peripheral side wall comprises a lower wall portion and an upper wall portion interconnected by a filter retainer disposed to engage said intermediate filter member to retain said removable filter within said filter pan during use, said filter retainer comprises a filter retainer member including a filter retaining surface disposed to engage a portion of the upper surface of said intermediate filter member when said filter pan is rotated during use.
